(19) United States
(12) Patent Application Publication
(10) Pub. No.: US 2025/0150229 A1
(43) Pub. Date: May 8, 2025

(54) METHOD AND DEVICE IN NODES USED FOR WIRELESS COMMUNICATION

(71) Applicants: Qi JIANG, Shanghai (CN); Congcong MEI, Shanghai (CN); Xiaobo ZHANG, Shanghai (CN)

(72) Inventors: Qi JIANG, Shanghai (CN); Congcong MEI, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/921,036

(22) Filed: Oct. 21, 2024

(30) Foreign Application Priority Data
Nov. 3, 2023 (CN) 202311461339.7

(51) Int. Cl. H04L 5/00; H04W 64/00

(52) U.S. Cl. CPC H04L 5/0048; H04W 64/00

(57) ABSTRACT

The present application discloses a method and device in a node for wireless communications. A first node receives a first signaling and a second signaling, wherein the first signal is used to configure a first RS resource, and a first radio resource depends on the second signaling; receives a first reference signal in the first RS resource; the first RS resource is used for positioning, and whether a reception for the first reference signal is used for positioning depends on whether the first reference signal is associated with the first radio resource; a transmitter of the first signaling is different from a transmitter of the second signaling, and a transmitter of the second signaling is the same as a transmitter of the first reference signal. The present application improves the performance of NR positioning in RIS scenarios.

### CROSS REFERENCE TO RELATED APPLICATIONS

The present application claims the priority benefit of Chinese Patent Application No. 202311461339.7, filed on Nov. 3, 2023, the full disclosure of which is incorporated herein by reference.

### BACKGROUND

### Technical Field

The present application relates to transmission methods and devices in wireless communication systems, and in particular to a positioning method and device in NR system.

### Related Art

In 2020, the vision of 5.5G industry for 5G evolution was first proposed by the industrial circles. In April 2021, the 3rd Generation Partner Project (3GPP) officially identified the name of 5.5G for 5G evolution as 5G-Advanced, which marks the start of the standardization process, and planned to define the 5G-Advanced technical specifications through Rel-18 (i.e., Release-18), Rel-19 and Rel-20. By the end of 2021, the Rel-18 has approved 28 projects, and 5.5G technology research and standardization has entered a substantial stage. Future Rel-19 and Rel-20 will further explore new 5G-Advanced services and architectures.

Reconfigurable Intelligent Surface (RIS) is an artificial electromagnetic surface structure with programmable electromagnetic properties, containing a large number of independent low-cost passive sub-wavelength resonant units. Each RIS unit has independent electromagnetic wave modulation capability, and the response of each unit to radio signals, such as phase, amplitude, polarization, etc., can be controlled by changing the parameters and spatial distribution of the RIS units. Through the superposition of wireless response signals of a large number of RIS units, specific beam propagation characteristics are formed on the macro level, thus forming a flexible and controllable formed beam to eliminate the coverage of blind zones, enhance the edge of the coverage and achieve the effect of increasing the rank of multi-stream transmission. RIS technology is characterized by low cost, low energy consumption and programmability, and is easy to deploy, and obtains high beamforming gain with larger antenna size, and thus is regarded as a key technology for research in the 5G-Advanced phase and one of the core visions of 6G.

### SUMMARY

In the current NR (New Radio) positioning system, the UE learns configuration information of a downlink positioning reference signal of the base station according to data provided by the positioning server, the positioning server can also transmit the configuration information to the base station, then the UE receives the positioning reference signal transmitted by the base station according to the configuration information, and then the UE reports the result to the positioning server afterward to realize positioning. However, when the system supports RIS technology, the signal reflected through RIS may have an effect on the positioning reference signal, or the signal reflected through RIS has same spatial characteristics as the positioning reference signal transmitted downlink from the base station, which leads to inaccurate positioning of the UE and reduces the performance of the NR positioning system.

To address the above problem, the present application provides a solution. It should be noted that, in response to the above problem description, NR positioning system is used as an example, and the present application is also applicable to scenarios such as future 6G systems, achieving technical effects similar to NR positioning systems; furthermore, although the original intention of the present application is to target RIS scenarios, it can also be applied to other non-RIS scenarios; adopting a unified design scheme for different scenarios (such as other non-RIS scenarios, including but not limited to capacity enhancement systems, coverage enhancement systems, short-range communication systems, unlicensed frequency-domain communications, IoT (Internet of Things), URLLC (Ultra Reliable Low Latency Communication) networks, Internet of Vehicles (IoV), etc.) can also help reduce hardware complexity and costs. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

Particularly, for interpretations of the terminology, nouns, functions and variants (if not specified) in the present application, refer to definitions given in TS38 series and TS37 series of 3GPP specifications. Where required, reference may be made to 3GPP standards TS38.211, TS38.212, TS38.213, TS38.214, TS38.215, TS38.300, TS38.304, TS38.305, TS38.321, TS38.331, TS37.355, TS38.423, TS38.455, to aid in the understanding of the present application.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:

receiving a first signaling and a second signaling, the first signaling being used to configure a first RS resource, a first radio resource depending on the second signal; receiving a first reference signal in the first RS resource;

herein, the first RS resource is used for positioning, and whether a reception for the first reference signal is used for positioning depends on whether the first reference signal is associated with the first radio resource; a transmitter of the first signaling is different from a transmitter of the second signaling, and a transmitter of the second signaling is the same as a transmitter of the first reference signal.

In one embodiment, a problem to be solved in the present application comprises: the first node in the present application determines whether a reception for the first reference signal is used for positioning.

In one embodiment, a problem to be solved in the present application comprises: in the RIS scenario, the first node in the present application determines whether a reception for the first reference signal is used for positioning.

In one embodiment, a problem to be solved in the present application comprises: the first node in the present application judges whether the first reference signal is associated with the first radio resource.

In one embodiment, a problem to be solved in the present application comprises: how the first node in the present application performs positioning according to the first RS resource.

In one embodiment, characteristics of the above method comprise: determining whether a reception for the first reference signal is used for positioning according to whether the first reference signal is associated with the first radio resource is conducive to improving the reliability of the positioning system.

In one embodiment, characteristics of the above method comprise: determining whether a reception for the first reference signal is used for positioning according to whether at least one of time-domain resources, frequency-domain resources, or spatial-domain resources occupied by the first reference signal and the first radio resource are the same.

In one embodiment, characteristics of the above method comprise: determining whether a reception for the first reference signal is used for positioning according to whether at least one of scrambling code, CDM (Code Division Multiplexing) type, port(s), TCI (Transmission Configuration Indicator), TCI-State, TCI-StateId, or QCL adopted for the first reference signal and a radio signal transmitted in the first radio resource is the same.

In one embodiment, characteristics of the above method comprise: determining whether a reception for the first reference signal is used for positioning according to whether one of spatial reception parameters of the first reference signal and a radio signal transmitted in the first radio resource are the same.

In one embodiment, characteristics of the above method comprise: the first node in the present application measures at least one of RSRP (Reference Signal Receiving Power) information, RSTD (Reference Signal Time Difference) information, and Rx-Tx time difference information obtained from a radio signal transmitted in the first RS resource to determine longitude, latitude, altitude, and other location-related information of the first node.

In one embodiment, characteristics of the above method comprise: a transmitter of the first signaling comprises LMF (Location Management Function).

In one embodiment, characteristics of the above method comprise: a transmitter of the second signaling comprises a base station.

In one embodiment, characteristics of the above method comprise: the first signaling used to configure the first RS resource is transmitted by the LMF to the UE. In one embodiment, advantages of the above approach include: optimizing the positioning performance in RIS scenarios, and helping the base station and UE to obtain accurate location information.

In one embodiment, advantages of the above methods include: enhancing the system's resistance to interference signals and improving robustness.

In one embodiment, advantages of the above methods include: saving resources, reducing power consumption, and preventing the system from positioning in the presence of strong interference signals.

In one embodiment, advantages of the above methods include: the present application supports the coexistence of RIS technology and positioning technology in 5G systems and future 6G systems. According to one aspect of the present application, the above method is characterized in that the first reference signal is associated with the first radio resource, and a reception for the first reference signal is used for positioning; or, the first reference signal is not associated with a first radio resource, and a reception for the first reference signal is not used for positioning.

In one embodiment, characteristics of the above method include: the first reference signal comprises a positioning reference signal.

In one embodiment, characteristics of the above method comprise: measuring at least one of RSRP information, RSTD information, and Rx-Tx time difference information obtained from the first reference signal to determine longitude, latitude, altitude, and other location-related information of the first node in the present application.

In one embodiment, characteristics of the above method include: the first reference signal is associated with the first radio resource, and a radio signal transmitted in the first radio resource causes strong interference to the first reference signal used for positioning. At this time, the first node in the present application does not use the first reference signal for positioning, or does not consider location-related information obtained based on the first reference signal.

In one embodiment, characteristics of the above method include: the first reference signal is not associated with the first radio resource, a radio signal transmitted in the first radio resource does not cause strong interference to the first reference signal used for positioning, or a radio signal transmitted in the first radio resource causes less interference to the first reference signal used for positioning, and in this case, the first node in the present application uses the first reference signal to obtain location-related information.

In one embodiment, advantages of the above method include: improving the reliability of positioning technology.

In one embodiment, advantages of the above method include: improving the accuracy of the obtained location-related information.

In one embodiment, advantages of the above method include: reducing power consumption, saving resources, and improving robustness of the system.

According to one aspect of the present application, the method is characterized in that the first radio resource comprises a second reference signal, and the meaning of the phrase that the first reference signal is associated with the first radio resource comprises that the first reference signal and the second reference signal are spatially correlated.

In one embodiment, characteristics of the above method include: the first reference signal and the second reference signal being spatially correlated refers to that at least one of time-domain resources, frequency-domain resources, or spatial-domain resources occupied by the first reference signal and the second reference signal are the same.

In one embodiment, characteristics of the above method include: the first reference signal and the second reference signal being spatially correlated refers to that at least one of scrambling code, CDM, port(s), TCI, TCI-State, TCI-StateId, and QCL adopted by the first reference signal and the second reference signal is the same.

In one embodiment, characteristics of the above method include: the first reference signal and the second reference signal being spatially correlated refers to that one of spatial reception parameters adopted by the first reference signal and the second reference signal is the same.

In one embodiment, characteristics of the above method comprise: judging whether the first reference signal is associated with the first radio resource according to a spatial relation between the first reference signal and the second reference signal.

In one embodiment, advantages of the above method include: improving the reliability of positioning technology.

In one embodiment, advantages of the above method include: improving the accuracy of the obtained location-related information.

In one embodiment, advantages of the above method include: reducing power consumption, saving resources, and improving robustness of the system.

In one embodiment, advantages of the above method include: avoiding the system from using the interfered first reference signal for positioning measurement.

In one embodiment, advantages of the above method include: avoiding the system from using the interfered first reference signal for demodulation.

According to one aspect of the present application, the method is characterized in that the first radio resource comprises a first time-domain resource set, and the meaning of the phrase that the first reference signal is associated with the first radio resource comprises that the first time-domain resource set comprises time-domain resources occupied by the first reference signal.

In one embodiment, characteristics of the above method include: the first time-domain resource set comprising time-domain resources occupied by the first reference signal refers to that the first time-domain resource set overlaps with time-domain resources occupied by the first reference signal, or time-domain resources occupied by the first reference signal are the first time-domain resource set.

In one embodiment, characteristics of the above method include: whether the first time-domain resource set comprises time-domain resources occupied by the first reference signal is used to judge whether the first reference signal is associated with the first radio resource.

In one embodiment, characteristics of the above method include: the first time-domain resource set is explicitly or implicitly indicated by the second signaling.

In one embodiment, advantages of the above methods include: improving the reliability of positioning technology and enhancing the accuracy of obtained location-related information in the RIS scenario.

In one embodiment, advantages of the above method include: reducing power consumption, saving resources, and improving robustness of the system.

According to one aspect of the present application, the above method is characterized in that the first radio resource is configured to a first device, the first node is a terminal, the first device is a device other than a terminal, and the first device is used to reflect a radio signal transmitted by a transmitter of the second signaling.

In one embodiment, characteristics of the above method include: the first device corresponds to an RIS.

In one embodiment, characteristics of the above method include: the first link is a link between the second node and the first device, and the second link is a link between the first device and the first node.

In one embodiment, characteristics of the above method include: the first link is a link between a base station and an RIS, and the second link is a link between an RIS and a terminal.

In one embodiment, characteristics of the above method include: the first device is an RIS.

In one embodiment, characteristics of the above method include: an RIS reflects a radio signal transmitted by a base station, thereby changing at least one of parameters such as amplitude, phase, polarization, and frequency of a radio signal transmitted by the base station.

In one embodiment, advantages of the above method comprise: the present application supports RIS technology, thereby improving the system flexibility.

In one embodiment, advantages of the above method comprise: an RIS provides extra links for signal transmission, enhancing the network coverage.

According to one aspect of the present application, the above method is characterized in that a radio link between a transmitter of the second signaling and the first device is a first link, and a radio link between the first device and a terminal is a second link; the second reference signal is only configured to a latter one of the first link and the second link.

In one embodiment, characteristics of the above method comprise: the second reference signal is configured to the second link.

In one embodiment, characteristics of the above method comprise: the first node in the present application can determine partial or all of time-domain resources, frequency-domain resources, scrambling ID, period, QCL, density, number of port(s), cycle shift, OCC (Orthogonal Cover Code), transmission sequence, and TCI of the second reference signal transmitted on the second link.

In one embodiment, advantages of the above method include: improving the flexibility of the system.

In one embodiment, advantages of the above method include: simplifying system design and having good backward compatibility.

According to one aspect of the present application, the above method is characterized in that a radio link between a transmitter of the second signaling and the first device is a first link, and a radio link between the first device and a terminal is a second link; the first time-domain resource set is only configured to a latter one of the first link and the second link.

In one embodiment, characteristics of the above method comprise: the first time-domain resource set is configured to the second link.

In one embodiment, characteristics of the above method comprise: the first node in the present application determines part or all of time-domain resources occupied by a radio signal transmitted on the second link, a number of time-domain resources occupied, a type of time-domain resources occupied, a time-domain position of a slot occupied, a position of a slot occupied in a cycle, a time-domain position of a multicarrier symbol occupied, a position of a multicarrier symbol occupied in a cycle, a position of a multicarrier symbol occupied in a slot, a time-domain position of a slot occupied by a multicarrier symbol occupied, and a position of a slot occupied by a multicarrier symbol occupied in a cycle according to the first time-domain resource set.

In one embodiment, advantages of the above method include: effectively managing interference and improving the performance of the positioning system.

In one embodiment, advantages of the above method include: improving the flexibility of the system.

According to one aspect of the present application, the above method is characterized in that the first node is a UE.

According to one aspect of the present application, the above method is characterized in that the first node is a relay node.

The present application provides a method in a second node for wireless communications, comprising:

transmitting a second signaling, a first radio resource depending on the second signaling; transmitting a first reference signal in a first RS resource;

herein, a first signaling is used to configure the first RS resource; the first RS resource is used for positioning, and whether a reception for the first reference signal is used for positioning depends on whether the first reference signal is associated with the first radio resource; a transmitter of the first signaling is different from the second node.

According to one aspect of the present application, the above method is characterized in that the first reference signal is associated with the first radio resource, and a reception for the first reference signal is used for positioning; or, the first reference signal is not associated with a first radio resource, and a reception for the first reference signal is not used for positioning.

According to one aspect of the present application, the method is characterized in that the first radio resource comprises a second reference signal, and the meaning of the phrase that the first reference signal is associated with the first radio resource comprises that the first reference signal and the second reference signal are spatially correlated.

According to one aspect of the present application, the method is characterized in that the first radio resource comprises a first time-domain resource set, and the meaning of the phrase that the first reference signal is associated with the first radio resource comprises that the first time-domain resource set comprises time-domain resources occupied by the first reference signal.

According to one aspect of the present application, the above method is characterized in that the first radio resource is configured to a first device, the first node is a terminal, the first device is a device other than a terminal, and the first device is used to reflect a radio signal transmitted from the second node.

According to one aspect of the present application, the above method is characterized in that a radio link between the second node and the first device is a first link, and a radio link between the first device and a terminal is a second link; the second reference signal is only configured to a latter one of the first link and the second link.

According to one aspect of the present application, the above method is characterized in that a radio link between the second node and the first device is a first link, and a radio link between the first device and a terminal is a second link; the first time-domain resource set is only configured to a latter one of the first link and the second link.

According to one aspect of the present application, the above method is characterized in that the second node is a base station.

According to one aspect of the present application, the above method is characterized in that the second node is a relay node.

The present application provides a first node for wireless communications, comprising:

a first receiver, receiving a first signaling and a second signaling, the first signaling being used to configure a first RS resource, a first radio resource depending on the second signal; receiving a first reference signal in the first RS resource;

herein, the first RS resource is used for positioning, and whether a reception for the first reference signal is used for positioning depends on whether the first reference signal is associated with the first radio resource; a transmitter of the first signaling is different from a transmitter of the second signaling, and a transmitter of the second signaling is the same as a transmitter of the first reference signal.

The present application provides a second node for wireless communications, comprising:

a first transmitter, transmitting a second signaling, a first radio resource depending on the second signaling; transmitting a first reference signal in a first RS resource;

herein, a first signaling is used to configure the first RS resource; the first RS resource is used for positioning, and whether a reception for the first reference signal is used for positioning depends on whether the first reference signal is associated with the first radio resource; a transmitter of the first signaling is different from the second node.

In one embodiment, compared to conventional solutions, the present application has the following favorable, but not limited, advantages:

improving the reliability and robustness of transmission, and enhancing the performance of the system;

improving the flexibility of the system, which is conducive to adapting to constantly changing scenarios;

effectively managing interference and improving the accuracy of positioning information;

reducing power consumption, resource waste and redundancy, and network costs.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of signal transmission between a first node and a second node according to one embodiment of the present application;

FIG. 6 illustrates a flowchart of signal transmission between a first node and a third node according to one embodiment of the present application;

FIG. 7 illustrates a flowchart of whether a first reference signal is used for positioning according to one embodiment of the present application;

FIG. 8 illustrates a schematic diagram of a first reference signal and a second reference signal being spatially correlated according to one embodiment of the present application;

FIG. 9 illustrates a schematic diagram of a first reference signal and a first time-domain resource set according to one embodiment of the present application;

FIG. 10 illustrates a schematic diagram of a first device used for signal reflection according to one embodiment of the present application;

FIG. 11 illustrates a schematic diagram of a second reference signal configured only to a second link according to one embodiment of the present application;

FIG. 12 illustrates a schematic diagram of a first reference signal configured only to a second link according to one embodiment of the present application;

FIG. 13 illustrates a structure block diagram of a processor in a first node according to one embodiment of the present application;

FIG. 14 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of transmission of a first node according to one embodiment of the present application, as shown in FIG. 1. In FIG. 1, each block represents a step. And in particular, the order of steps in boxes does not represent chronological order of characteristics between the steps.

A first node receives a first signaling and a second signaling in step 101, the first signaling is used to configure a first RS resource, a first radio resource depends on the second signal; in step 102, a first node receives a first reference signal in the first RS resource.

In embodiment 1, the first RS resource is used for positioning, and whether a reception for the first reference signal is used for positioning depends on whether the first reference signal is associated with the first radio resource; a transmitter of the first signaling is different from a transmitter of the second signaling, and a transmitter of the second signaling is the same as a transmitter of the first reference signal.

In one embodiment, the first signaling is earlier than a second signaling.

In one embodiment, the first signaling is later than a second signaling.

In one embodiment, the first signaling is earlier than a first reference signal.

In one embodiment, the first signaling is later than a first reference signal.

In one embodiment, the second signaling is earlier than a first reference signal.

In one embodiment, the second signaling is later than a first reference signal.

In one embodiment, a transmitter of the first signaling is the third node in the present application.

In one embodiment, the third node in the present application comprises LMF (Location Management Function).

In one embodiment, the third node in the present application comprises an E-SMLC (Enhanced Serving Mobile Location Centre).

In one embodiment, the third node in the present application comprises an SLP (SUPL Location Platform).

In one embodiment, the third node in the present application comprises a location server.

In one embodiment, the third node in the present application comprises an AMF (Access and Mobility Management Function) module.

In one embodiment, the third node in the present application comprises an LMF module.

In one embodiment, the third node in the present application is an LMF module.

In one embodiment, the first signaling is transmitted via a radio interface.

In one embodiment, the first signaling is transmitted wirelessly.

In one embodiment, the second node in the present application comprises a base station.

In one embodiment, the second node in the present application comprises gNB.

In one embodiment, the second node in the present application comprises ng-eNB.

In one embodiment, the second node in the present application comprises a cell.

In one embodiment, the second node in the present application comprises a serving cell.

In one embodiment, the second signaling is transmitted via a radio interface.

In one embodiment, the second signaling is transmitted wirelessly.

In one embodiment, the positioning protocol in the present application comprises TS 37.355.

In one embodiment, the positioning protocol in the present application comprises TS 38.215.

In one embodiment, the positioning protocol in the present application comprises TS 38.305.

In one embodiment, the positioning protocol in the present application comprises TS 38.455.

In one embodiment, the first node is the first node in the present application.

In one embodiment, the first node in the present application comprises a UE.

In one embodiment, the first node in the present application comprises a SET (SUPL enabled Terminal).

In one embodiment, the first signaling belongs to LPP (LTE Positioning Protocol) messages.

In one embodiment, the first signaling belongs to LPP.

In one embodiment, the first signaling comprises partial or all fields in an NR-DL-PRS-Info IE in the positioning protocol.

In one embodiment, the first signaling comprises an NR-DL-PRS-Info IE in the positioning protocol.

In one embodiment, the first signaling comprises partial or all fields in an NR-DL-PRS-AssistanceData IE in the positioning protocol.

In one embodiment, the first signaling comprises an NR-DL-PRS-AssistanceData IE in the positioning protocol.

In one embodiment, the first signaling comprises partial or all fields in an NR-DL-PRS-BeamInfo IE in the positioning protocol.

In one embodiment, the first signaling comprises an NR-DL-PRS-BeamInfo IE in the positioning protocol.

In one embodiment, the first signaling comprises partial or all fields in an NR-DL-PRS-ExpectedLOS-NLOS-Assistance IE in the positioning protocol.

In one embodiment, the first signaling comprises an NR-DL-PRS-ExpectedLOS-NLOS-Assistance IE in the positioning protocol.

In one embodiment, the first signaling comprises all or partial fields in an NR-DL-PRS-ResourceID IE in the positioning protocol. In one embodiment, the first signaling comprises an NR-DL-PRS-ResourceID IE in the positioning protocol.

In one embodiment, the first signaling comprises partial or all fields in an NR-DL-PRS-ResourceSetID IE in the positioning protocol.

In one embodiment, the first signaling comprises an NR-DL-PRS-ResourceSetID IE in the positioning protocol.

In one embodiment, the first signaling comprises partial or all fields in an NR-DL-PRS-TRP-TEG-Info IE in the positioning protocol.

In one embodiment, the first signaling comprises an NR-DL-PRS-TRP-TEG-Info IE in the positioning protocol.

In one embodiment, the first signaling comprises partial or all fields in an NR-On-Demand-DL-PRS-Configurations IE in the positioning protocol.

In one embodiment, the first signaling comprises an NR-On-Demand-DL-PRS-Configurations IE in the positioning protocol.

In one embodiment, the first signaling comprises partial or all fields in an NR-On-Demand-DL-PRS-Information IE in the positioning protocol.

In one embodiment, the first signaling comprises an NR-On-Demand-DL-PRS-Information IE in the positioning protocol.

In one embodiment, the first signaling comprises partial or all fields in an NR-On-Demand-DL-PRS-Configurations-Selected-IndexList IE in the positioning protocol.

In one embodiment, the first signaling comprises an NR-On-Demand-DL-PRS-Configurations-Selected-IndexList IE in the positioning protocol.

In one embodiment, the first signaling comprises partial or all fields in an NR-SelectedDL-PRS-IndexList IE in the positioning protocol.

In one embodiment, the first signaling comprises an NR-SelectedDL-PRS-IndexList IE in the positioning protocol.

In one embodiment, the first signaling comprises information of a downlink positioning reference signal (PRS) of multiple TRPs.

In one embodiment, the first signaling comprises downlink PRS information of a TRP.

In one embodiment, the first signaling comprises at least one of time-domain resources, frequency-domain resources, and radio resources corresponding to a downlink PRS.

In one embodiment, a name of the first signaling comprises DL.

In one embodiment, a name of the first signaling comprises PRS.

In one embodiment, a name of the first signaling comprises Positioning.

In one embodiment, a name of the first signaling comprises RIS.

In one embodiment, a name of the first signaling comprises IRS (Intelligent Reflecting Surface).

In one embodiment, a name of the first signaling comprises Info.

In one embodiment, the first signaling belongs to LPP configuration.

In one embodiment, the first signaling belongs to LPPa (LTE Positioning Protocol annex) configuration.

In one embodiment, the meaning of “being used for configuration” in the present application comprises: indicating.

In one embodiment, the meaning of “being used for configuration” in the present application comprises: comprising.

In one embodiment, the meaning of “being used for configuration” in the present application comprises: explicitly indicating.

In one embodiment, the meaning of “being used for configuration” in the present application comprises: implicitly indicating.

In one embodiment, the first signaling being used to configure a first RS resource comprises: the first signaling indicates frequency-domain resources occupied by the first RS resource.

In one embodiment, the first signaling being used to configure a first RS resource comprises: the first signaling indicates time-domain resources occupied by the first RS resource.

In one embodiment, the first signaling being used to configure a first RS resource comprises: the first signaling indicates a configuration period of the first RS resource.

In one embodiment, the first signaling being used to configure a first RS resource comprises: the first signaling indicates MutingPattern of the first RS resource.

In one embodiment, the first signaling being used to configure a first RS resource comprises: the first signaling indicates RepetitionFactor of the first RS resource.

In one embodiment, the first signaling being used to configure a first RS resource comprises: the first signaling indicates TimeGap of the first RS resource.

In one embodiment, the first signaling being used to configure a first RS resource comprises: the first signaling indicates ResourceSetSlotOffset of the first RS resource.

In one embodiment, the first signaling being used to configure a first RS resource comprises: the first signaling indicates CombSizeN of the first RS resource.

In one embodiment, the first signaling being used to configure a first RS resource comprises: the first signaling indicates ResourceBandwidth of the first RS resource.

In one embodiment, the first signaling being used to configure a first RS resource comprises: the first signaling indicates StartingPRB of the first RS resource.

In one embodiment, the first signaling being used to configure a first RS resource comprises: the first signaling indicates ResourceId of the first RS resource.

In one embodiment, the first signaling being used to configure a first RS resource comprises: the first signaling indicates SequenceId of the first RS resource.

In one embodiment, the first signaling being used to configure a first RS resource comprises: the first signaling indicates ReOffset of the first RS resource.

In one embodiment, the first signaling being used to configure a first RS resource comprises: the first signaling indicates ResourceSlotOffset of the first RS resource.

In one embodiment, the first signaling being used to configure a first RS resource comprises: the first signaling indicates ResourceSymbolOffset of the first RS resource.

In one embodiment, the first signaling being used to configure a first RS resource comprises: the first signaling indicates NumSymbols of the first RS resource.

In one embodiment, the first signaling being used to configure a first RS resource comprises: the first signaling indicates a QCL relation of the first RS resource.

In one embodiment, the first signaling being used to configure a first RS resource comprises: the first signaling indicates SSB-Index QCLed with the first RS resource.

In one embodiment, the first signaling being used to configure a first RS resource comprises: the first signaling indicates CSI-RS resourceId QCLed with the first RS resource.

In one embodiment, the first signaling being used to configure a first RS resource comprises: the first signaling indicates an NZP-CSI-RS-ResourceId QCLed with the first RS resource.

In one embodiment, the first signaling being used to configure a first RS resource comprises: the first signaling indicates at least one of relevant parameters of the first RS resource.

In one embodiment, the QCL in the present application refers to: Quasi Co-Location.

In one embodiment, the QCL in the present application refers to: Quasi Co-Located.

In one embodiment, the QCL in the present application comprises a QCL parameter.

In one embodiment, the QCL in the present application comprises a QCL assumption.

In one embodiment, the QCL types in the present application comprise TypeA, TypeB, TypeC, and TypeD.

In one embodiment, the QCL types in the present application comprise a QCL type other than TypeA, TypeB, TypeC, and TypeD.

In one embodiment, QCL parameters with the QCL type of TypeA in the present application comprise Doppler shift, Doppler spread, average delay and delay spread; QCL parameters with the QCL type of TypeB comprise Doppler shift and Doppler spread; QCL parameters with the QCL type of TypeC comprise Doppler shift and an average delay; QCL parameters with the QCL type of TypeD comprise spatial Rx parameter.

In one embodiment, the QCL in the present application comprises at least one of Doppler shift, Doppler spread, average delay, delay spread, spatial Tx parameter, or spatial reception parameter.

In one embodiment, for specific definitions of the TypeA, the TypeB, the TypeC and the TypeD in the present application, refer to clause 5.1.5 in 3GPP TS 38.214.

In one embodiment, the first RS resource is used for transmitting a PRS.

In one embodiment, the first RS resource comprises a PRS resource.

In one embodiment, the first RS resource comprises one or multiple PRS resources.

In one embodiment, the first RS resource comprises a PRS resource set.

In one embodiment, the first RS resource comprises one or multiple PRS resource sets.

In one embodiment, the first RS resource comprises a positioning frequency layer.

In one embodiment, the first RS resource comprises one or multiple positioning frequency layers.

In one embodiment, the first RS resource corresponds to a PRS resourceId (Identification).

In one embodiment, the first RS resource corresponds to an NR-DL-PRS-ResourceID-r16.

In one embodiment, the first RS resource corresponds to an NR-DL-PRS-ResourceID-rx, where the label “rx” is one of r18, r19, or r20.

In one embodiment, the PRS resourceId in the present application is used to identify the PRS resource.

In one embodiment, the PRS resourceId in the present application is an index of the PRS resource.

In one embodiment, the PRS resourceId in the present application comprises a configuration index of the PRS resource.

In one embodiment, the PRS resourceId in the present application is a configuration index of the PRS resource.

In one embodiment, the first RS resource corresponds to an NR-DL-PRS-ResourceSetID-r16.

In one embodiment, the first RS resource corresponds to an NR-DL-PRS-ResourceSetID-rx, where the label “rx” is one of r18, r19, or r20.

In one embodiment, the first RS resource corresponds to a PRS resource set.

In one embodiment, the first RS resource corresponds to a PRS resource set Id.

In one embodiment, the RS resource set Id in the present application is used to identify the RS resource set.

In one embodiment, the RS resource set Id in the present application is an index of the RS resource set.

In one embodiment, the RS resource set Id in the present application comprises a configuration index of the RS resource set.

In one embodiment, the first RS resource corresponds to an nr-DL-PRS-Positioning FrequencyLayer-r16.

In one embodiment, the first RS resource corresponds to an nr-DL-PRS-Positioning FrequencyLayer-rx, where the label “rx” is one of r18, r19, or r20.

In one embodiment, the first RS resource is used for transmitting a CSI-RS.

In one embodiment, the first RS resource comprises a CSI-RS resource.

In one embodiment, the first RS resource comprises one or multiple CSI-RS resources.

In one embodiment, the first RS resource comprises to a CSI-RS resource set.

In one embodiment, the first RS resource comprises one or multiple CSI-RS resource sets.

In one embodiment, the first RS resource is identified by a CSI-RS-ResourceId.

In one embodiment, the first RS resource is identified by a CSI-RS-ResourceSetId.

In one embodiment, the first RS resource comprises an NZP-CSI-RS resource.

In one embodiment, the first RS resource comprises one or multiple NZP-CSI-RS resources.

In one embodiment, the first RS resource comprises an NZP-CSI-RS resource set.

In one embodiment, the first RS resource comprises one or multiple NZP-CSI-RS resource sets.

In one embodiment, the first RS resource is identified by an NZP-CSI-RS-ResourceId.

In one embodiment, the first RS resource is identified by an NZP-CSI-RS-ResourceSetId.

In one embodiment, the first RS resource is used for transmitting an SSB.

In one embodiment, the SSB in the present application refers to: a Synchronization Signal Block.

In one embodiment, the SSB in the present application refers to: an SS (Synchronization Signal)/PBCH (Physical Broadcast Channel) block.

Typically, reception occasions of PBCH, PSS (Primary Synchronization Signal), and SSS (Secondary Synchronization Signal) are in continuous symbols and form an SS/PBCH block.

In one embodiment, the first RS resource comprises an SSB resource.

In one embodiment, the first RS resource comprises one or multiple SSB resources.

In one embodiment, the first RS resource comprises an SSB resource set.

In one embodiment, the first RS resource comprises one or multiple SSB resource sets.

In one embodiment, the first RS resource is identified by an SRS-ResourceId.

In one embodiment, the first RS resource is identified by an SRS-ResourceSetId.

In one embodiment, the first RS resource comprises one or multiple ports.

In one embodiment, the port comprises a PRS port.

In one embodiment, the port comprises a CSI-RS port.

In one embodiment, the port comprises an SRS port.

In one embodiment, the port comprises an antenna port.

In one embodiment, the port is a PRS port.

In one embodiment, the port is a CSI-RS port.

In one embodiment, the port is an SRS port.

In one embodiment, the port is an antenna port.

In one embodiment, the first RS resource occupies at least one symbol in time domain.

In one embodiment, the first RS resource occupies multiple consecutive symbols in time domain.

In one embodiment, the first RS resource occupies a slot in time domain.

In one embodiment, the first RS resource occupies a sub-frame in time domain.

In one embodiment, the first RS resource occupies at least one sub-band in frequency domain.

In one embodiment, the first RS resource occupies at least one RB (Resource Block) in frequency domain.

Typically, an RB occupies 12 consecutive subcarriers in frequency domain.

In one embodiment, the first RS resource occupies a group of downlink PRBs (Physical Resource Blocks).

In one embodiment, the first RS resource occupies at least one RE (Resource Element).

Typically, an RE occupies a symbol in time domain and a subcarrier in frequency domain.

In one embodiment, the first reference signal comprises a PRS.

In one embodiment, the first reference signal comprises an SSB.

In one embodiment, the first reference signal comprises a CSI-RS.

In one embodiment, the first reference signal comprises a GNSS (Global Navigation Satellite System) signal.

In one embodiment, the first reference signal is a PRS.

In one embodiment, the first reference signal is an SSB.

In one embodiment, the first reference signal is a CSI-RS.

In one embodiment, the first reference signal is an NZP CSI-RS.

In one embodiment, the first reference signal is a GNSS signal.

In one embodiment, the first reference signal group is acquired through satellite.

In one embodiment, the first reference signal is obtained through GNSS.

In one embodiment, the first reference signal is obtained through Secure User Plane Location.

In one embodiment, the first reference signal group is acquired based on LPP protocol.

In one embodiment, the first reference signal group is acquired based on LPPa protocol.

In one embodiment, the first reference signal corresponds to a PRS identity.

In one embodiment, the first reference signal corresponds to an SSB-Index.

In one embodiment, the first reference signal corresponds to an ssb-Index.

In one embodiment, the first reference signal corresponds to a CSI-RS identity.

In one embodiment, the first reference signal is used to determine position related information of the first node.

In one embodiment, location-related information of the first node comprises at least one of longitude, latitude, and altitude at which the first node is located.

In one embodiment, location-related information of the first node comprises a latitude and longitude zone corresponding to a longitude and a latitude where the first node is located.

In one embodiment, location-related information of the first node comprises a spatial region corresponding to longitude, latitude, and altitude.

In one embodiment, location-related information of the first node is related to a zone identifier corresponding to the first node.

In one subembodiment of the embodiment, the zone identifier is a cell Id.

In one subembodiment of the embodiment, the zone identifier is a non-negative integer.

In one subembodiment of the embodiment, the zone identifier corresponds to a pair of integers, which are respectively used to represent a horizontal position and a vertical position of the first node relative to a reference point.

In one subembodiment of the embodiment, the zone identifier corresponds to a pair of integers, which are respectively used to represent a longitude position and a latitude position of the first node relative to a reference point.

In one subembodiment of the embodiment, the zone identifier corresponds to a pair of integers, which are respectively used to represent a horizontal position and a vertical position of the first node relative to a reference point.

In one subembodiment of the embodiment, the zone identifier corresponds to third integers, which are respectively used to represent a horizontal position, a vertical position, and an altitude of the first node relative to a reference point.

In one subembodiment of the embodiment, the zone identifier corresponds to third integers, which are respectively used to represent a horizontal position, a vertical position, and an altitude of the first node relative to a reference point.

In one subembodiment of the embodiment, the zone identifier corresponds to three integers, which are respectively used to represent a longitude position, a latitude position, and an altitude of the first node relative to a reference point.

In one embodiment, location-related information of the first node comprises a distance of the first node relative to a reference point.

In one embodiment, location-related information of the first node comprises a location of the first node relative to a reference point.

In one embodiment, location-related information of the first node comprises an angle of the first node relative to a reference point.

In one embodiment, location-related information of the first node comprises at least one of distance, position, and angle of the first node relative to a reference point.

In one embodiment, location-related information of the first node comprises at least one of distance, location, and angle of the first node relative to multiple reference points.

In one embodiment, location-related information of the first node comprises an AoD (Angle of Departure) corresponding to the first node upon receiving a first reference signal.

In one embodiment, the meaning of the first RS resource being used for positioning comprises: a radio signal received in the first RS resource is used for positioning.

In one embodiment, the meaning of the first RS resource being used for positioning comprises: a reception of a radio signal transmitted in the first RS resource is used for positioning.

In one embodiment, the meaning of the first RS resource being used for positioning comprises: RSRP (Reference Signal Receiving Power) information obtained by measuring a radio signal transmitted in the first RS resource is used for positioning.

In one embodiment, the meaning of the first RS resource being used for positioning comprises: RSTD (Reference Signal Time Difference) information obtained by measuring a radio signal transmitted in the first RS resource is used for positioning.

In one embodiment, the meaning of the first RS resource being used for positioning comprises: Rx-Tx time difference information obtained by measuring a radio signal transmitted in the first RS resource is used for positioning.

In one embodiment, positioning in the present application comprises positioning of the first node.

In one embodiment, positioning in the present application comprises positioning of the second node.

In one embodiment, positioning in the present application comprises positioning of the third node.

In one embodiment, positioning in the present application comprises measuring.

In one embodiment, positioning in the present application comprises demodulating.

In one embodiment, the positioning method used in the present application comprises at least one of OTDOA (Observed Time Difference of Arrival) positioning, A-GNSS positioning, Enhanced Cell ID positioning, Terrestrial Beacon System positioning, Sensor based positioning, WLAN-based positioning, Bluetooth-based positioning, NR E-CID (NR Enhanced Cell ID) positioning, NR DL-TDOA (Downlink Time Difference of Arrival) positioning, NR DL-AoD (Downlink Angle-of-Spare) positioning, or NR Multi-Round Trip Time (Multi-RTT) Positioning.

In one embodiment, the second signaling comprises a higher-layer signaling.

In one embodiment, the second signaling comprises an RRC signaling.

In one embodiment, the second signaling is RRC.

In one embodiment, the second signaling is transmitted through an RRC signaling.

In one embodiment, the second signaling comprises one or multiple RRC IEs (Information Elements).

In one embodiment, the second signaling comprises one or multiple fields in at least one RRC IE.

In one embodiment, the second signaling comprises all or partial fields in each RRC IE in multiple RRC IEs.

In one embodiment, the second signaling comprises one or multiple fields in a CellGroupConfig IE.

In one embodiment, the second signaling comprises one or multiple fields in a ServingCellConfig IE.

In one embodiment, the second signaling comprises one or multiple fields in a ServingCellConfigCommonSIB IE.

In one embodiment, the second signaling comprises one or multiple fields in a ServingCellConfigCommon IE.

In one embodiment, the second signaling comprises a MAC CE.

In one embodiment, the second signaling comprises a MAC layer signaling.

In one embodiment, the second signaling is a MAC CE.

In one embodiment, the second signaling is transmitted through a MAC CE (Control Element).

In one embodiment, the RRC layer refers to: Radio Resource Control layer.

In one embodiment, the MAC layer refers to: Medium Access Control layer.

In one embodiment, the second signaling comprises a physical-layer signaling.

In one embodiment, the second signaling comprises Downlink Control Information (DCI).

In one embodiment, the second signaling is DCI.

In one embodiment, the second signaling comprises partial or all fields in a DCI format. In one subembodiment of the embodiment, the first information block comprises partial or all fields in DCI format 2_X, where X is a non-negative integer.

In one embodiment, a physical-layer channel occupied by the second signaling comprises a Physical Downlink Control Channel (PDCCH).

In one embodiment, a physical-layer channel occupied by the second signaling comprises a Physical Downlink Shared Channel (PDSCH).

In one embodiment, the second signaling is transmitted on a downlink physical control channel (i.e., a downlink channel only capable of bearing a physical-layer signaling).

In one embodiment, the second signaling is transmitted on a downlink physical data channel (i.e., a downlink channel capable of bearing physical-layer data).

In one embodiment, a transmission channel occupied by the second signaling comprises a Downlink Shared Channel (DL-SCH).

In one embodiment, the second signaling comprises a CSI-AperiodicTriggerStateList IE.

In one embodiment, the second signaling comprises one or multiple fields in a CSI-Aperiodic TriggerStateList IE.

In one embodiment, the second signaling comprises a CSI-IM-Resource IE.

In one embodiment, the second signaling comprises one or multiple fields in a CSI-IM-Resource IE.

In one embodiment, the second signaling comprises a CSI-IM-ResourceSet IE.

In one embodiment, the second signaling comprises one or multiple fields in a CSI-IM-ResourceSet IE.

In one embodiment, the second signaling comprises a CSI-MeasConfig IE.

In one embodiment, the second signaling comprises one or multiple fields in a CSI-MeasConfig IE.

In one embodiment, the second signaling comprises a CSI-ReportConfig IE.

In one embodiment, the second signaling comprises one or multiple fields in a CSI-ReportConfig IE.

In one embodiment, the second signaling comprises a CSI-ResourceConfig IE.

In one embodiment, the second signaling comprises one or multiple fields in CSI-ResourceConfig IE.

In one embodiment, the second signaling comprises an NZP-CSI-RS-Resource IE.

In one embodiment, the second signaling comprises one or multiple fields in an NZP-CSI-RS-Resource IE.

In one embodiment, the second signaling comprises an NZP-CSI-RS-ResourceSet IE.

In one embodiment, the second signaling comprises one or multiple fields in an NZP-CSI-RS-ResourceSet IE.

In one embodiment, the second signaling comprises an NZP-CSI-RS-Resource IE.

In one embodiment, the second signaling comprises one or multiple fields in an NZP-CSI-RS-Resource IE.

In one embodiment, the second signaling comprises an NZP-CSI-RS-ResourceSet IE.

In one embodiment, the second signaling comprises one or multiple fields in an NZP-CSI-RS-ResourceSet IE.

In one embodiment, the second signaling comprises a CSI-SSB-ResourceSet IE.

In one embodiment, the second signaling comprises one or multiple fields in a CSI-SSB-ResourceSet IE.

In one embodiment, the second signaling comprises an SSB-Index IE.

In one embodiment, the second signaling comprises one or multiple fields in an SSB-Index IE.

In one embodiment, the second signaling comprises an SSB-ToMeasure IE.

In one embodiment, the second signaling comprises one or multiple fields in an SSB-ToMeasure IE.

In one embodiment, the second signaling comprises an SSB-PositionQCL-Relation IE.

In one embodiment, the second signaling comprises one or multiple fields in an SSB-PositionQCL-Relation IE.

In one embodiment, the second signaling comprises one or multiple fields in an NR-DL-PRS-PDC-Info IE.

In one embodiment, the second signaling comprises an SP CSI-RS/CSI-IM Resource Set Activation/Deactivation MAC CE.

In one embodiment, the second signaling comprises an SP ZP CSI-RS Resource Set Activation/Deactivation MAC CE.

In one embodiment, a name of the second signaling comprises CSI-RS.

In one embodiment, a name of the second signaling comprises SSB.

In one embodiment, a name of the second signaling comprises PRS.

In one embodiment, a name of the second signaling comprises Muting.

In one embodiment, a name of the second signaling comprises RIS.

In one embodiment, a name of the second signaling comprises IRS.

In one embodiment, a name of the second signaling comprises DISABLE.

In one embodiment, a name of the second signaling comprises OFF.

In one embodiment, a name of the second signaling comprises RS.

In one embodiment, a name of the second signaling comprises ON.

In one embodiment, a name of the second signaling comprises ENABLE.

In one embodiment, the meaning of the first radio resource depending on the second signaling comprises: the second signaling indicates time-domain resources occupied by the first radio resource.

In one embodiment, the meaning of the first radio resource depending on the second signaling comprises: the second signaling indicates frequency-domain resources occupied by the first radio resource.

In one embodiment, the meaning of the first radio resource depending on the second signaling comprises: the second signaling indicates spatial-domain resources occupied by the first radio resource.

In one embodiment, the meaning of the first radio resource depending on the second signaling comprises: the second signaling indicates a QCL relation corresponding to the first radio resource.

In one embodiment, the meaning of the first radio resource depending on the second signaling comprises: the second signaling indicates reference signal resources spatially correlated with the first radio resource space.

In one embodiment, the meaning of the first radio resource depending on the second signaling comprises: the second signaling indicates an SSB-Index QCLed with the first radio resource.

In one embodiment, the meaning of the first radio resource depending on the second signaling comprises: the second signaling indicates a CSI-RS resourceId QCLed with the first radio resource.

In one embodiment, the meaning of the first radio resource depending on the second signaling comprises: the second signaling indicates an NZP-CSI-RS-ResourceId QCLed with the first radio resource.

In one embodiment, the first radio resource comprises reference signal resources.

In one embodiment, the first radio resource comprises time-domain resources.

In one embodiment, the first radio resource comprises frequency-domain resources.

In one embodiment, the first radio resource comprises spatial-domain resources.

In one embodiment, the first radio interface resource comprises at least one of time-domain resources, frequency-domain resources, and spatial-domain resources.

In one embodiment, the meaning of the characteristic of receiving a first reference signal on a first RS resource comprises: receiving the first reference signal in an RE corresponding to the first RS resource.

In one embodiment, the meaning of the characteristic of receiving a first reference signal on a first RS resource comprises: receiving the first reference signal on an OFDM symbol corresponding to the first RS resource.

In one embodiment, the meaning of the characteristic of receiving a first reference signal on a first RS resource comprises: receiving the first reference signal according to power control parameters of the first RS resource.

In one embodiment, the meaning of the characteristic of receiving a first reference signal on a first RS resource comprises: receiving the first reference signal according to spatial reception parameters of the first RS resource.

In one embodiment, the meaning of the characteristic of receiving a first reference signal on a first RS resource comprises: receiving the first reference signal according to configuration information of the first RS resource.

In one embodiment, the Spatial Rx parameters in the present application comprise at least one of a receiving beam, a receiving analog beamforming matrix, a receiving analog beamforming vector, a receiving beamforming matrix, a receiving beamforming vector and a spatial-domain reception filter.

In one embodiment, configuration information of the first RS resource in the present application comprises part or all of time-domain resources, frequency-domain resources, CDM (Code Division Multiplexing) type, scramblingID, period, QCL, density, number of port(s), cycle shift, OCC (Orthogonal Cover Code), transmission sequence, and TCI (Transmission Configuration Indicator).

In one embodiment, the meaning of the characteristic that “whether a reception for the first reference signal is used for positioning depends on whether the first reference signal is associated with the first radio resource” comprises: the first reference signal is associated with the first radio resource, and a reception for the first reference signal is used for positioning, or the first reference signal is not associated with a first radio resource, and a reception for the first reference signal is not used for positioning.

In one embodiment, the meaning of the characteristic that “whether a reception for the first reference signal is used for positioning depends on whether the first reference signal is associated with the first radio resource” comprises: the first reference signal is associated with the first radio resource, and a reception for the first reference signal is not used for positioning, or the first reference signal is not associated with the first radio resource, and a reception for the first reference signal is used for positioning.

### Embodiment 2

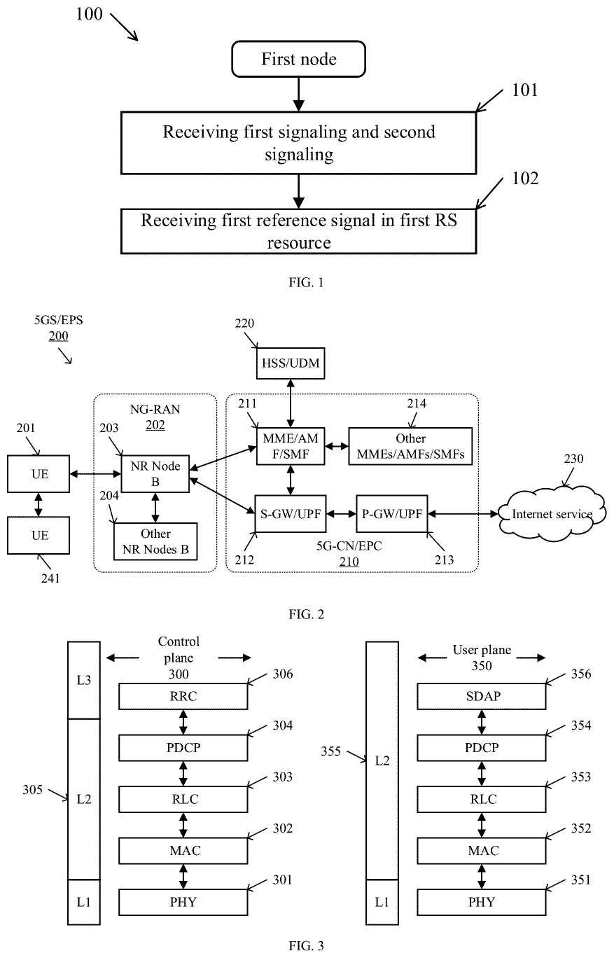

Embodiment 2 illustrates a schematic diagram of a network architecture according to one embodiment of the present application, as shown in FIG. 2.

FIG. 2 is a diagram illustrating a network architecture of Long-Term Evolution (LTE), Long-Term Evolution Advanced (LTE-A) and future 5G systems. The LTE, LTE-A and future 5G systems network architecture 200 may be called an Evolved Packet System (EPS). The 5G NR or LTE network architecture may be called a 5G System (5GS)/Evolved Packet System (EPS) 200 or other appropriate terms. 5GS/EPS 200 may include one or more UEs 201, a UE 241 for sidelink communication with UE 201, NG-RAN (Next Generation Radio Access Network) 202, 5G-CN (5G Core Network)/EPC (Evolved Packet Core) 210, HSS (Home subscriber server)/UDM (Unified Data Management) 220, and Internet service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. NG-RAN 202 comprises NR Node B (gNB) 203 and other gNBs 204. The gNB 203 provides UE 201-oriented user plane and control plane protocol terminations. The gNB 203 may connect to other gNBs 204 via an Xn interface (e.g., backhaul). The gNB 203 may also be referred to as a base station, base transceiver station, radio base station, radio transceiver, transceiver function, Basic Service Set (BSS), Extended Service Set (ESS), TRP (Transmitter Receiver Point), or some other suitable terms. The gNB 203 provides an access point for UE 201 to 5G-CN/EPC 210. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), air vehicles, narrow-band physical network devices, machine-type communication devices, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5G-CN/EPC 210 via an S1/NG interface. 5G-CN/EPC 210 includes MME (Mobility Management Entity)/AMF (Authentication Management Field)/SMF (Session Management Function) 211, other MME/AMF/SMF 214, S-GW (Service Gateway)/UPF (User Plane Function) 212, and P-GW (Packet Date Network Gateway)/UPF 213. The MME/AMF/SMF 211 is a control node for processing a signaling between the UE 201 and the 5G-CN/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. Internet Services 230 includes operator-corresponding Internet Protocol services, which may specifically include Internet, Intranet, IMS (IP Multimedia Subsystem) and packet switching services.

In one embodiment, the first node in the present application comprises the UE 201.

In one embodiment, the second node in the present application comprises the gNB 203.

In one embodiment, the UE 201 comprises a mobile phone.

In one embodiment, the UE 201 is a vehicle comprising a car.

In one embodiment, the gNB 203 is a Marco Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, the gNB 203 is a test device (e.g., a transceiver device simulating partial functions of a base station, a signaling tester).

In one embodiment, a radio link from the UE 201 to the gNB 203 is an uplink, and the uplink is used for executing an uplink transmission.

In one embodiment, a radio link from the gNB 203 to the UE 201 is a downlink, and the downlink is used for executing a downlink transmission.

In one embodiment, a radio link between the UE 201 and the gNB 203 comprises a cellular network link.

In one embodiment, the UE 201 and the gNB 203 are connected via a Uu air interface.

In one embodiment, a transmitter of the second signaling comprises the gNB 203.

In one embodiment, a receiver of the second signaling comprises the UE 201.

In one embodiment, a transmitter of the first reference signal comprises the gNB 203.

In one embodiment, a receiver of the first reference signal comprises the UE 201.

In one embodiment, a receiver of the first signaling comprises the UE 201.

In one embodiment, the UE 201 supports RIS.

In one embodiment, the gNB 203 supports RIS.

In one embodiment, the UE 201 supports IRS.

In one embodiment, the gNB 203 supports IRS.

In one embodiment, the UE 201 supports a positioning system.

In one embodiment, the gNB 203 supports a positioning system.

In one embodiment, the UE 201 supports 5G system.

In one embodiment, the UE 201 supports 6G system.

In one embodiment, the gNB 203 supports 6G system.

In one embodiment, the UE 201 at least supports 6G system.

In one embodiment, the gNB 203 at least supports 6G system.

In one embodiment, the UE 201 supports irregular coverage.

### Embodiment 3

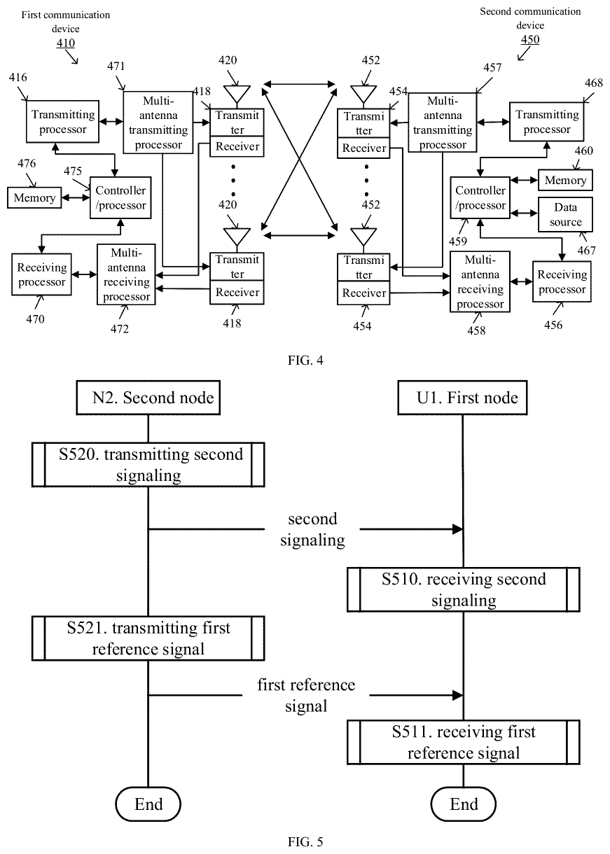

Embodiment 3 illustrates a schematic diagram of a radio protocol architecture of a user plane and a control plane according to one embodiment of the present application, as shown in FIG. 3.

FIG. 3 is a schematic diagram illustrating an embodiment of the radio protocol architecture for user plane 350 and control plane 300. FIG. 3 shows a radio protocol architecture for a first communication node device (UE or RSU (Road Side Unit) in V2X (Vehicle to Everything), vehicle-mounted device or vehicle-mounted communication module) and a second node device (gNB, UE or RSU in V2X, vehicle-mounted device or vehicle-mounted communication module), or the control plane 300 between two UEs in three layers: Layer 1 (L1), Layer 2 (L2) and Layer 3 (L3). L1 is the lowest layer and implements various PHY (physical layer) signal processing functions. L1 will be referred to as PHY 301 in the present application. L2 305 is located above PHY 301 and is responsible for a link between the first node and the second node, or between two UEs, through the PHY 301. L2 305 includes MAC (Medium Access Control) sublayer 302, RLC (Radio Link Control) sublayer 303, and PDCP (Packet Data Convergence Protocol) sublayer 304, which terminate at the second node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of an upper-layer packet, retransmission of a lost packet, and reordering of a packet so as to compensate the disordered reception incurred by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 355 in the user plane 350 also includes Service Data Adaptation Protocol (SDAP) sublayer 356, which is responsible for the mapping between QoS (Quality of Service) flow and Data Radio Bearer (DRB) to support the diversity of traffic. Although not shown, the first communication node device has several upper layers above L2 355, including a network layer (e.g., IP (Internet Protocol) layer) terminating at the P-GW on the network side and an application layer terminating at the other end of the connection (e.g., remote UE, server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the second signaling is generated by the RRC 306.

In one embodiment, the second signaling is generated by the MAC 302 or the MAC 352.

In one embodiment, the second signaling is generated by the PHY 301 or the PHY 351.

In one embodiment, the first reference signal is generated by the PHY 301 or the PHY 351.

In one embodiment, the higher layer in the present application refers to a layer above the physical layer.

In one embodiment, the higher layer in the present application comprises the MAC layer.

In one embodiment, the higher layer in the present application comprises the RRC layer.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 includes a controller/processor 475, a memory 476, a receiving processor 470, a transmitting processor 416, a multi-antenna receiving processor 472, a multi-antenna transmitting processor 471, a transmitter/receiver 418, and an antenna 420.

The second communication device 450 includes a controller/processor 459, a memory 460, a data source 467, a transmitting processor 468, a receiving processor 456, a multi-antenna transmitting processor 457, a multi-antenna receiving processor 458, a transmitter/receiver 454, and an antenna 452.

In a transmission from the first communication device 410 to the second communication device 450, at the first communication device 410, a higher-layer packet from the core network is provided to the controller/processor 475. The controller/processor 475 implements L2 functionality. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 (that is, PHY). The transmitting processor 416 implements encoding and interleaving to facilitate Forward Error Correction (FEC) at the second communication device 450, as well as mapping of signal clusters based on various modulation schemes such as Binary Phase Shift Keying (BPSK), Quadrature Phase Shift Keying (QPSK), M-ary Phase Shift Keying (M-PSK), and M-Quadrature Amplitude Modulation (M-QAM). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream to a subcarrier, multiplies the modulated symbols with a reference signal (e.g., pilot) in time domain and/or frequency domain, and subsequently uses an Inverse Fast Fourier Transform (IFFT) to generate a physical channel carrying a time-domain multicarrier symbol stream. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives signals through its corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 implement various signal processing functions of L1. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using Fast Fourier Transform (FFT). In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2, or various control signals can be provided to the L3 layer for processing. The controller/processor 459 is also responsible for error detection using ACKnowledgement (ACK) and/or Negative ACKnowledgement (NACK) protocols to support HARQ operations.

In a transmission from the second communication device 450 to the first communication device 410, the data source 467 is used at the second communication device 450 to provide upper layer data packets to the controller/processor 459. The data source 467 represents all protocol layers above the L2. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 functions used for the user plane and the control plane. The controller/processor 459 is also responsible for HARQ operation, retransmission of a lost packet, and a signaling to the first communication device 410. The transmitting processor 468 performs modulation, mapping and channel coding processing, the multi-antenna transmitting processor 457 performs digital multi-antenna spatial precoding, including codebook-based precoding and non-codebook-based precoding, as well as beamforming. Subsequently, the transmitting processor 468 modulates the generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the symbol stream to the antenna 452.

In a transmission from the second communication device 450 to the first communication device 410, the function at the first communication device 410 is similar to the receiving function at the second communication device 450 described in a transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly implement the function of L1. The controller/processor 475 implements L2 function. The controller/processor 475 can be connected with the memory 476 that stores program code and data. The memory 476 can be called a computer readable medium. The controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives a first signaling and a second signaling, the first signaling is used to configure a first RS resource, a first radio resource depends on the second signal; receives a first reference signal in the first RS resource; herein, the first RS resource is used for positioning, and whether a reception for the first reference signal is used for positioning depends on whether the first reference signal is associated with the first radio resource; a transmitter of the first signaling is different from a transmitter of the second signaling, and a transmitter of the second signaling is the same as a transmitter of the first reference signal.

In one embodiment, the second communication device 450 comprises a memory that stores a computer readable instruction program. The computer readable instruction program generates an action when executed by at least one processor. The action includes: receiving a first signaling and a second signaling, receiving a first reference signal in the first RS resource.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits a second signaling, and a first radio resource depends on the second signaling; transmits a first reference signal in the first RS resource, and a first signaling is used to configure the first RS resource; herein, the first RS resource is used for positioning, and whether a reception for the first reference signal is used for positioning depends on whether the first reference signal is associated with the first radio resource; a transmitter of the first signaling is different from the second node.

In one embodiment, the first communication device 410 comprises a memory that stores a computer readable instruction program. The computer readable instruction program generates an action when executed by at least one processor. The action includes: transmitting a second signaling, transmitting a first reference signal in the first RS resource.

In one embodiment, the first node comprises the second communication device 450 in the present application.

In one embodiment, the second node in the present application comprises the first communication device 410.

In one embodiment, at least one of the antenna 420, the transmitter 418, the transmitting processor 416, the multi-antenna transmitting processor 471, the controller/processor 475, or the memory 476 is used to transmit a second signaling; at least one of the antenna 452, the receiver 454, the receiving processor 456, the multi-antenna receiving processor 458, the controller/processor 459, the memory 460, and the data source 467 is used to receive a second signaling.

In one embodiment, at least one of the antenna 420, the transmitter 418, the transmitting processor 416, the multi-antenna transmitting processor 471, the controller/processor 475, or the memory 476 is used to transmit a first reference signal in the first RS resource; at least one of the antenna 452, the receiver 454, the receiving processor 456, the multi-antenna receiving processor 458, the controller/processor 459, the memory 460, or the data source 467 is used to receive a first reference signal in the first RS resource.

In one embodiment, at least one of the antenna 452, the receiver 454, the receiving processor 456, the multi-antenna receiving processor 458, the controller/processor 459, the memory 460, or the data source 467 is used to receive a second signaling.

### Embodiment 5

Embodiment 5 illustrates a flowchart of signal transmission between a first node and a second node according to one embodiment of the present application. In FIG. 5, a first node Ul and a second node N2 are in communications via a radio link. It is particularly underlined that the order illustrated in the embodiment does not put constraints over sequences of signal transmissions and implementations.

The second node N2 transmits a second signaling in step S520; transmits a first reference signal in step S521.

The first node Ul receives a second signaling in step S510; receives a first reference signal in step S511.

In embodiment 5, the first RS resource is used for positioning, and whether a reception for the first reference signal is used for positioning depends on whether the first reference signal is associated with the first radio resource; a transmitter of the first signaling is different from a transmitter of the second signaling, and a transmitter of the second signaling is the same as a transmitter of the first reference signal.

In one embodiment, the first node Ul is the first node in the present application.

In one embodiment, the second node N2 is the second node in the present application.

In one embodiment, the meaning of the characteristic that “a transmitter of the first signaling is different from a transmitter of the second signaling” comprises: a transmitter of the first signaling is the third node, and a transmitter of the second signaling is the second node.

In one embodiment, the meaning of the characteristic that “a transmitter of the first signaling is different from a transmitter of the second signaling” comprises: a transmitter of the first signaling is the third node, a transmitter of the second signaling is the second node, the second node is a base station, and the third node is an LMF.

In one embodiment, the meaning of the characteristic that “a transmitter of the first signaling is different from a transmitter of the second signaling” comprises: time-domain resources occupied by the third node transmitting the first signaling and the second node transmitting the second signal are different.

In one embodiment, the meaning of the characteristic that “a transmitter of the first signaling is different from a transmitter of the second signaling” comprises: time-domain resources occupied by the third node transmitting the first signaling and the second node transmitting the second signaling are the same, but frequency-domain resources are different.

In one embodiment, the meaning of the characteristic that “a transmitter of the second signaling is the same as a transmitter of the first reference signal” comprises: a transmitter of both the second signaling and the first reference signal is the second node.

In one embodiment, the meaning of the characteristic that “a transmitter of the second signaling is the same as a transmitter of the first reference signal” comprises: the second signaling and the first reference signal are transmitted by a same base station on different time-frequency resources.

In one embodiment, the meaning of the characteristic that “a transmitter of the second signaling is the same as a transmitter of the first reference signal” comprises: the second signaling and the first reference signal are transmitted by a same base station on same time-domain resources but different frequency-domain resources.

In one embodiment, the meaning of the characteristic that “a transmitter of the second signaling is the same as a transmitter of the first reference signal” comprises: the second signaling and the first reference signal are transmitted by a same base station on different time-domain resources but same frequency-domain resources.

### Embodiment 6

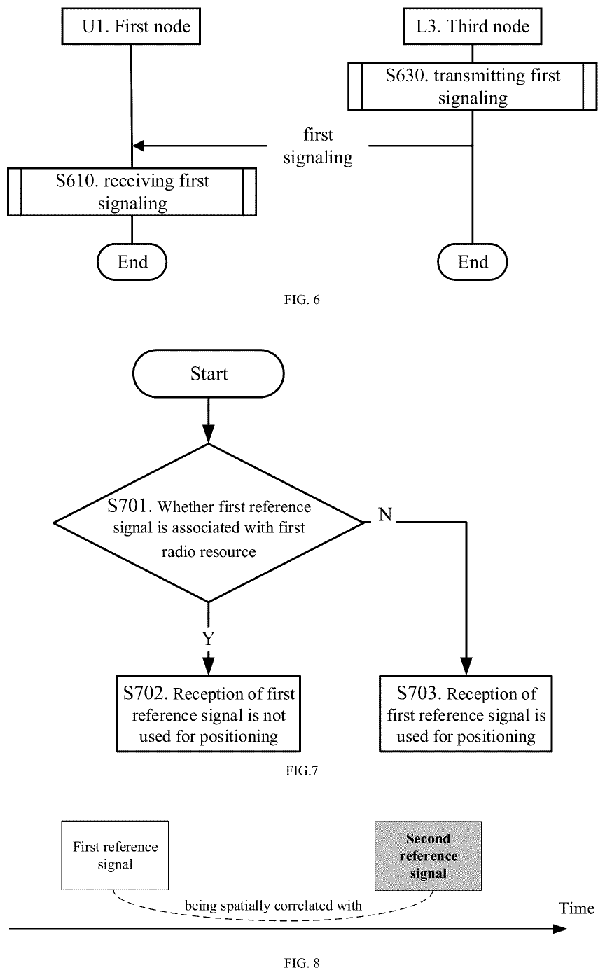

Embodiment 6 illustrates a flowchart of signal transmission between a first node and a third node according to one embodiment of the present application. In FIG. 6, a first node U1 and a third node L3 are in communications via a radio link. It is particularly underlined that the order illustrated in the embodiment does not put constraints over sequences of signal transmissions and implementations.

The third node L3 transmits a first signaling in step S630.

The first node U1 receives a first signaling in step S610.

In embodiment 6, the first signaling is used to configure a first RS resource.

In one embodiment, the first node U1 is the first node in the present application.

In one embodiment, the third node L3 is the third node in the present application.

In one embodiment, an air interface between the third node L3 and the first node U1 comprises a radio interface between a positioning server and a UE.

In one embodiment, an air interface between the third node L3 and the first node U1 comprises a radio interface between an LMF and a UE.

In one embodiment, the first signaling is used to determine configuration information of a positioning reference signal.

In one embodiment, the first signaling comprises configuration information of a positioning reference signal.

In one embodiment, the first signaling comprises the first RS resource.

In one embodiment, the first signaling indicates the first RS resource.

### Embodiment 7

Embodiment 7 illustrates a flowchart of whether a first reference signal is used for positioning according to one embodiment of the present application, in FIG. 7, the first reference signal is associated with the first radio resource, and a reception for the first reference signal is used for positioning; or, the first reference signal is not associated with a first radio resource, and a reception for the first reference signal is not used for positioning.

In one embodiment, the first node independently determines whether the first reference signal is associated with the first radio resource.

In one embodiment, the first node determines whether the first reference signal is associated with the first radio resource according to an RRC signaling.

In one embodiment, the first node determines whether the first reference signal is associated with the first radio resource according to a signaling from LMF.

In one embodiment, the first node implementation-relatedly determines whether the first reference signal is associated with the first radio resource.

In one embodiment, when the first reference signal is associated with the first radio resource, a reception for the first reference signal is used for positioning.

In one embodiment, when the first reference signal is not associated with a first radio resource, a reception for the first reference signal is not used for positioning.

In one embodiment, the meaning of “the first reference signal being associated with the first radio resource” comprises: there exists an overlapping between REs occupied by the first reference signal and REs occupied by the first radio resource.

In one embodiment, the meaning of “the first reference signal not being associated with the first radio resource” comprises: there does not exist an overlapping between REs occupied by the first reference signal and REs occupied by the first radio resource.

In one embodiment, the meaning of “the first reference signal being associated with the first radio resource” comprises: frequency-domain resources occupied by the first reference signal are the same as frequency-domain resources occupied by the first radio resource.

In one embodiment, the meaning of “the first reference signal not being associated with the first radio resource” comprises: frequency-domain resources occupied by the first reference signal are different from frequency-domain resources occupied by the first radio resource.

In one embodiment, the meaning of “the first reference signal being associated with the first radio resource” comprises: frequency-domain resources occupied by the first reference signal are the same as time-domain resources occupied by the first radio resource.

In one embodiment, the meaning of “the first reference signal not being associated with the first radio resource” comprises: frequency-domain resources occupied by the first reference signal are different from time-domain resources occupied by the first radio resource.

In one embodiment, the meaning of “the first reference signal being associated with the first radio resource” comprises: frequency-domain resources occupied by the first reference signal are the same as spatial-domain resources occupied by the first radio resource.

In one embodiment, the meaning of “the first reference signal not being associated with the first radio resource” comprises: frequency-domain resources occupied by the first reference signal are different from spatial-domain resources occupied by the first radio resource.

In one embodiment, the meaning of “the first reference signal being associated with the first radio resource” comprises: the first reference signal and a radio signal transmitted in the first radio resource adopt a same scrambling code.

In one embodiment, the meaning of “the first reference signal not being associated with the first radio resource” comprises: the first reference signal and a radio signal transmitted in the first radio resource adopt different scrambling codes.

In one embodiment, the meaning of “the first reference signal being associated with the first radio resource” comprises: the first reference signal and a radio signal transmitted in the first radio resource are both associated with a same PCI.

In one embodiment, the meaning of “the first reference signal not being associated with the first radio resource” comprises: the first reference signal and a radio signal transmitted in the first radio resource are respectively associated with different PCIs.

In one embodiment, the meaning of “the first reference signal being associated with the first radio resource” comprises: the first reference signal and a radio signal transmitted in the first radio resource adopt a same CDM type.

In one embodiment, the meaning of “the first reference signal not being associated with the first radio resource” comprises: the first reference signal and a radio signal transmitted in the first radio resource adopt different CDM types.

In one embodiment, the meaning of “the first reference signal being associated with the first radio resource” comprises: the first reference signal and a radio signal transmitted in the first radio resource adopt a same port.

In one embodiment, the meaning of “the first reference signal not being associated with the first radio resource” comprises: the first reference signal and a radio signal transmitted in the first radio resource adopt different ports.

In one embodiment, the meaning of “the first reference signal being associated with the first radio resource” comprises: the first reference signal and a radio signal transmitted in the first radio resource adopt a same TCI.

In one embodiment, the meaning of “the first reference signal not being associated with the first radio resource” comprises: the first reference signal and a radio signal transmitted in the first radio resource adopt different TCIs.

In one embodiment, the meaning of “the first reference signal being associated with the first radio resource” comprises: the first reference signal and a radio signal transmitted in the first radio resource correspond to a same TCI-State.

In one embodiment, the meaning of “the first reference signal not being associated with the first radio resource” comprises: the first reference signal and a radio signal transmitted in the first radio resource correspond to different TCI-States.

In one embodiment, the meaning of “the first reference signal being associated with the first radio resource” comprises: the first reference signal and a radio signal transmitted in the first radio resource correspond to a same TCI-StateId.

In one embodiment, the meaning of “the first reference signal not being associated with the first radio resource” comprises: the first reference signal and a radio signal transmitted in the first radio resource correspond to different TCI-StateIds.

In one embodiment, the meaning of “the first reference signal being associated with the first radio resource” comprises: the first reference signal and a radio signal transmitted in the first radio resource are QCLed.

In one embodiment, the meaning of “the first reference signal not being associated with the first radio resource” comprises: the first reference signal and a radio signal transmitted in the first radio resource are not QCLed.

In one embodiment, the meaning of “the first reference signal being associated with the first radio resource” comprises: the first reference signal and a radio signal transmitted in the first radio resource adopt part or all of same time-domain resources, frequency-domain resources, CDM type, scrambling code identifier, period, QCL, density, number of port(s), cyclic shift, OCC, and TCI.

In one embodiment, the meaning of “the first reference signal being associated with the first radio resource” comprises: the first reference signal and a radio signal transmitted in the first radio resource adopt a same spatial reception parameter.

In one embodiment, the meaning of “the first reference signal not being associated with the first radio resource” comprises: the first reference signal and a radio signal transmitted in the first radio resource adopt different spatial reception parameters.

In one embodiment, the meaning of “the first reference signal being associated with the first radio resource” comprises: the first reference signal and a radio signal transmitted in the first radio resource adopt a same reception spatial filtering.

In one embodiment, the meaning of “the first reference signal not being associated with the first radio resource” comprises: the first reference signal and a radio signal transmitted in the first radio resource adopt different reception spatial filterings.

In one embodiment, the meaning of “the first reference signal being associated with the first radio resource” comprises: the first reference signal and a radio signal transmitted in the first radio resource adopt different DL RX Spatial Filters.

In one embodiment, the meaning of “the first reference signal not being associated with the first radio resource” comprises: the first reference signal and a radio signal transmitted in the first radio resource adopt different DL RX Spatial Filters.

In one embodiment, the meaning of “the first reference signal being associated with the first radio resource” comprises: the first reference signal and a radio signal transmitted in the first radio resource adopt a same spatial filtering.

In one embodiment, the meaning of “the first reference signal not being associated with the first radio resource” comprises: the first reference signal and a radio signal transmitted in the first radio resource adopt different spatial filterings.

In one embodiment, the meaning of “the first reference signal being associated with the first radio resource” comprises: the first reference signal and a radio signal transmitted in the first radio resource have part or all of same Doppler shift, Doppler spread, average delay, delay spread, spatial transmission parameters or spatial reception parameters.

In one embodiment, the meaning of a reception of the first reference signal being used for positioning comprises: RSRP information obtained by measuring the first reference signal is used for positioning.

In one embodiment, the meaning of a reception of the first reference signal being used for positioning comprises: RSTD information obtained by measuring the first reference signal is used for positioning.

In one embodiment, the meaning of a reception of the first reference signal being used for positioning comprises: Rx-Tx time difference information obtained by measuring the first reference signal is used for positioning.

In one embodiment, the meaning of a reception of the first reference signal being not used for positioning comprises: not measuring the first reference signal.

In one embodiment, the meaning of a reception of the first reference signal being not used for positioning comprises: RSRP information obtained by measuring the first reference signal is not used for positioning.

In one embodiment, the meaning of a reception of the first reference signal being not used for positioning comprises: RSTD information obtained by measuring the first reference signal is not used for positioning.

In one embodiment, the meaning of a reception of the first reference signal being not used for positioning comprises: Rx-Tx time difference information obtained by measuring the first reference signal is not used for positioning.

### Embodiment 8

Embodiment 8 illustrates a schematic diagram of a first reference signal and a second reference signal being spatially related according to one embodiment of the present application. In FIG. 8, the first radio resource comprises a second reference signal, and the meaning of the phrase that the first reference signal is associated with the first radio resource comprises that the first reference signal and the second reference signal are spatially correlated.

In one embodiment, the second reference signal comprises a CSI-RS.

In one embodiment, the second reference signal comprises an SSB.

In one embodiment, the second reference signal corresponds to a CSI-RS identity.

In one embodiment, the second reference signal corresponds to an SSB-Index.

In one embodiment, the second reference signal corresponds to an NZP-CSI-RS-ResourceId.

In one embodiment, the second reference signal is an SSB.

In one embodiment, the second reference signal is a CSI-RS.

In one embodiment, the second reference signal is an NZP-CSI-RS.

In one embodiment, the meaning of the characteristic that “the first radio resource comprises a second reference signal” comprises: the second reference signal is transmitted on the first radio resource.

In one embodiment, the meaning of the characteristic that “the first radio resource comprises a second reference signal” comprises: transmitting the second reference signal on the first radio resource.

In one embodiment, the meaning of the characteristic that “the first radio resource comprises a second reference signal” comprises: a radio signal transmitted on the first radio resource is the second reference signal.

In one embodiment, the meaning of the characteristic that “the first radio resource comprises a second reference signal” comprises: at least one of time-domain resources, frequency-domain resources, and spatial-domain resources occupied by the second reference signal is the first radio resource.

In one embodiment, the meaning of the above characteristic that “the first reference signal and the second reference signal are spatially related” comprises: the first reference signal and the second reference signal are QCLed.

In one embodiment, the meaning of the above characteristic that “the first reference signal and the second reference signal are spatially related” comprises: the first reference signal and the second reference signal use a same spatial reception parameter.

In one embodiment, the meaning of the above characteristic that “the first reference signal and the second reference signal are spatially related” comprises: the first reference signal and the second reference signal use a same spatial filtering.

In one embodiment, the meaning of the above characteristic that “the first reference signal and the second reference signal are spatially related” comprises: the first reference signal and the second reference signal use a same space filtering.

In one embodiment, the meaning of the above characteristic that “the first reference signal and the second reference signal are spatially related” comprises: the first reference signal and the second reference signal adopt a same DL RX Spatial Filter.

In one embodiment, the meaning of “the first reference signal and the second reference signal being spatially related” comprises: the first reference signal and the second reference signal have part or all of same Doppler shift, Doppler spread, average delay, delay spread, spatial transmission parameters or spatial reception parameters.

In one embodiment, the meaning of the above characteristic that “the first reference signal and the second reference signal are spatially related” comprises: the first node receives the first reference signal according to a spatial relation with reference to the second reference signal.

In one embodiment, the meaning of the above characteristic that “the first reference signal and the second reference signal are spatially related” comprises: the first node receives the second reference signal according to a spatial relation with reference to the first reference signal.

In one embodiment, the meaning of the above characteristic that “the first reference signal and the second reference signal are spatially related” comprises: the first reference signal and the second reference signal correspond to a same TCI.

In one embodiment, the meaning of the above characteristic that “the first reference signal and the second reference signal are spatially related” comprises: the first reference signal and the second reference signal correspond to a same TCI-State.

In one embodiment, the meaning of the above characteristic that “the first reference signal and the second reference signal are spatially related” comprises: the first reference signal and the second reference signal correspond to a same TCI-StateId.

### Embodiment 9

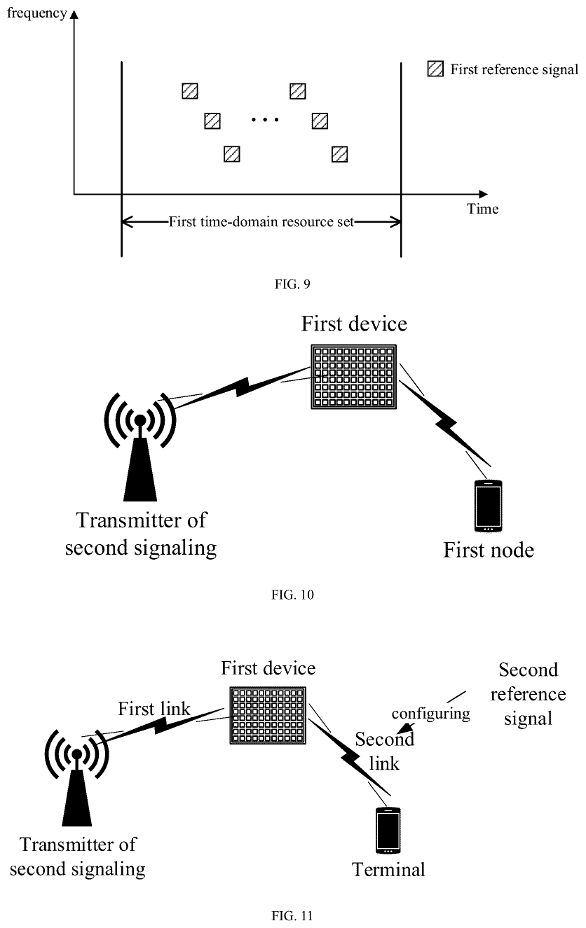

Embodiment 9 illustrates a schematic diagram of a first reference signal and a first time-domain resource set according to one embodiment of the present application. In FIG. 9, the first radio resource comprises a first time-domain resource set, and the meaning of the phrase that the first reference signal is associated with the first radio resource comprises that the first time-domain resource set comprises time-domain resources occupied by the first reference signal.

In one embodiment, the first time-domain resource set comprises one or multiple multicarrier symbols.

In one embodiment, the first time-domain resource set comprise one or multiple slots.

In one embodiment, the first time-domain resource set comprise one or multiple subframes.

In one embodiment, the first time-domain resource set comprises continuous time-domain resources.

In one embodiment, the first time-domain resource set comprises discontinuous time-domain resources.

In one embodiment, the first time-domain resource set comprises periodic time-domain resources.

In one embodiment, the first time-domain resource set comprises aperiodic time-domain resources.

In one embodiment, there at least exists one time resource only belonging to the first time-domain resource set, and the time resource being one of slot, subframe or multicarrier symbol.

In one embodiment, there at least exists one time unit only belonging to the first time-domain resource set, and the time unit being slot, subframe or a duration of an OFDM symbol, etc.

In one embodiment, the meaning of the characteristic that “the first radio resource comprises a first time-domain resource set” comprises: the first radio resource is the first time-domain resource set.

In one embodiment, the meaning of the characteristic that “the first radio resource comprises a first time-domain resource set” comprises: the first time-domain resource set belongs to the first radio resource.

In one embodiment, the second signaling indicates the first time-domain resource set.

In one embodiment, the second signaling indicates time-domain resources comprised in the first time-domain resource set.

In one embodiment, the second signaling indicates a number of time-domain resources comprised in the first time-domain resource set.

In one embodiment, the second signaling indicates configuration information of the first time-domain resource set.

In one embodiment, the second signaling indicates a type of time-domain resources comprised in the first time-domain resource set.

In one subembodiment of the embodiment, a type of the time-domain resources comprises one of periodic, semi-persistent and aperiodic.

In one embodiment, the second signaling indicates a time-domain location of a slot comprised in the first time-domain resource set.

In one embodiment, the second signaling indicates a location of a slot comprised in the first time-domain resource set within one cycle.

In one embodiment, the second signaling indicates a time-domain location of a multicarrier symbol comprised in the first time-domain resource set.

In one embodiment, the second signaling indicates a location of a multicarrier symbol comprised in the first time-domain resource set within one cycle.

In one embodiment, the second signaling indicates a location of a multicarrier symbol comprised in the first time-domain resource set within one slot.

In one embodiment, the second signaling indicates a time-domain location of a slot occupied by a multicarrier symbol comprised in the first time-domain resource set.

In one embodiment, the second signaling indicates a location of a slot occupied by a multicarrier symbol comprised in the first time-domain resource set within one cycle.

In one embodiment, the second signaling explicitly indicates the first time-domain resource set.

In one embodiment, the second signaling implicitly indicates the first time-domain resource set.

In one embodiment, time-domain resources occupied by the first reference signal comprise one or multiple multicarrier symbols.

In one embodiment, time-domain resources occupied by the first reference signal are located in one or multiple slots.

In one embodiment, time-domain resources occupied by the first reference signal are located in one or multiple subframes.

In one embodiment, the first reference signal occupies continuous time-domain resources in time domain.

In one embodiment, the first reference signal occupies discontinuous time-domain resources in time domain.

In one embodiment, the first reference signal occupies periodic time-domain resources in time domain.

In one embodiment, the first reference signal occupies aperiodic time-domain resources in time domain.

In one embodiment, the first device in the present application is only turned on in the first time-domain resource set.

In one embodiment, the first device in the present application is not turned off in the first time-domain resource set.

In one embodiment, the first device in the present application is only in the first time-domain resource set, and a state of the first device is set to “on”.

In one embodiment, the first device in the present application is not in the first time-domain resource set, and a state of the first device is set to “off”.

In one embodiment, the first device in the present application is only in the first time-domain resource set, and the first device is used to reflect a signal.

In one embodiment, the first device in the present application is not in the first time-domain resource set, and the first device is not used to reflect a signal.

In one embodiment, the multicarrier symbol in the present application is a Single Carrier-Frequency Division Multiple Access (SC-FDMA) symbol.

In one embodiment, the multicarrier symbol in the present application is a Filter Bank Multicarrier (FBMC) symbol.

In one embodiment, the multicarrier symbol in the present application is an Orthogonal Frequency Division Multiplexing (OFDM) symbol.

In one embodiment, the symbol in the present application is obtained after an output of transform precoding is through OFDM symbol generation.

In one embodiment, the multicarrier symbol in the present application is a Discrete Fourier Transform-spread-OFDM (DFT-S-OFDM) symbol.

In one embodiment, the multicarrier symbol in the present application comprises a CP-OFDM (Cyclic Prefix-OFDM).

In one embodiment, the meaning of the above technical effect that “the first time-domain resource set comprises time-domain resources occupied by the first reference signal” comprises: the first time-domain resource set are overlapping with time-domain resources occupied by the first reference signal.

In one embodiment, the meaning of the above technical effect that “the first time-domain resource set comprises time-domain resources occupied by the first reference signal” comprises: time-domain resources occupied by the first reference signal belong to the first time-domain resource set.

In one embodiment, the meaning of the above technical effect that “the first time-domain resource set comprises time-domain resources occupied by the first reference signal” comprises: time-domain resources occupied by the first reference signal are the first time-domain resource set.

### Embodiment 10

Embodiment 10 illustrates a schematic diagram of a first device used for signal reflection according to one embodiment of the present application. In FIG. 10, the first radio resource is configured to a first device, the first node is a terminal, the first device is a device other than a terminal, and the first device is used to reflect a radio signal transmitted by a transmitter of the second signaling.

In one embodiment, the first device comprises an RIS.

In one embodiment, the first device comprises an RIS group.

In one embodiment, the first device is an RIS.

In one embodiment, the first device is an RIS group.

In one embodiment, the first device comprises an RIS panel.

In one embodiment, the first device comprises multiple RIS panels.

In one embodiment, the first device comprises one or multiple RIS panels.

In one embodiment, the first device comprises a reconfigurable electromagnetic surface.

In one embodiment, the first device comprises one or more electromagnetic units.

In one embodiment, the first device comprises a feeding module.

In one subembodiment of the embodiment, the mode of the feeding module comprises a far-field reflection mode, a far-field transmissive mode, an active passive integration mode and a near-field transmissive mode.

In one embodiment, the first device comprises an RIS controller.

In one embodiment, the first device comprises an RIS control module.

In one embodiment, the first device can reflect incident electromagnetic waves.

In one embodiment, the first device can change at least one of parameters such as amplitude, phase, polarization, and frequency of the incident electromagnetic wave.

In one embodiment, the first device can be applied in low-frequency (Sub-6 GHZ), millimeter wave, terahertz, and optical frequency band.

In one embodiment, the first device can be controlled by at least one of devices/materials such as PIN tube, varactor diode, MEMS switch, liquid crystal, graphene, vanadium dioxide, etc.

In one embodiment, types of the first device comprise reflective type, transmissive type, and integrated reflective transmissive type.

In one embodiment, terms “RIS” and “IRS” in the present application are equivalent and interchangeable.

In one embodiment, the meaning of the characteristic that “the first device is used to reflect a radio signal transmitted by a transmitter of the second signaling” comprises: the first device reflects a radio signal transmitted by a transmitter of the second signaling, or the first device reflects a radio signal transmitted by the second node.

In one embodiment, the meaning of the characteristic that “the first device is used to reflect a radio signal transmitted by a transmitter of the second signaling” comprises: the first device reflects the first reference signal.

In one embodiment, the meaning of the characteristic that “the first device is used to reflect a radio signal transmitted by a transmitter of the second signaling” comprises: the first device changes at least one of parameters such as amplitude, phase, polarization, and frequency of the first reference signal.

In one embodiment, the meaning of the characteristic that “the first device is used to reflect a radio signal transmitted by a transmitter of the second signaling” comprises: the first device only reflects the first reference signal only in the first time-domain resource set.

In one embodiment, the meaning of the characteristic that “the first device is used to reflect a radio signal transmitted by a transmitter of the second signaling” comprises: the first device changes at least one of parameters such as amplitude, phase, polarization, and frequency of the first reference signal only in the first time-domain resource set.

### Embodiment 11

Embodiment 11 illustrates a schematic diagram of a second reference signal configured only for a second link according to one embodiment of the present application. In FIG. 11, a radio link between a transmitter of the second signaling and the first device is a first link, and a radio link between the first device and a terminal is a second link; the second reference signal is only configured to a latter one of the first link and the second link.

In one embodiment, the first link is a control link.

In one embodiment, the first link is for an RIS.

In one embodiment, the first link is a link between a base station and an RIS.

In one embodiment, the first link is an incident link from the base station to the RIS.

In one embodiment, the second link is an access link.

In one embodiment, the second link is a Forward Access link.

In one embodiment, the second link is a link between an RIS and the terminal.

In one embodiment, the second link is a reflection link from an RIS to the terminal.

In one embodiment, information is transmitted on the first link.

In one embodiment, information is received on the first link.

In one embodiment, information is transmitted on the second link.

In one embodiment, information is received on the second link.

In one embodiment, a corresponding relation between the first link and the second link is one of one-to-one, many to one, one to many, or many to many.

In one embodiment, the meaning of the characteristic that “the second reference signal is only configured to a latter one of the first link and the second link” comprises: the second reference signal is configured to the second link.

In one embodiment, the meaning of the characteristic that “the second reference signal is only configured to a latter one of the first link and the second link” comprises: the second reference signal is not configured to the first link.

In one embodiment, the meaning of the characteristic that “the second reference signal is only configured to a latter one of the first link and the second link” comprises: the second reference signal is transmitted on the second link.

In one embodiment, the meaning of the characteristic that “the second reference signal is only configured to a latter one of the first link and the second link” comprises: it is possible to determine part or all of time-domain resources, frequency-domain resource CDM type, scrambling code identifier, period, QCL, density, number of port(s), cyclic shift, OCC, transmission sequence, and TCI of the second reference signal transmitted on the second link.

### Embodiment 12

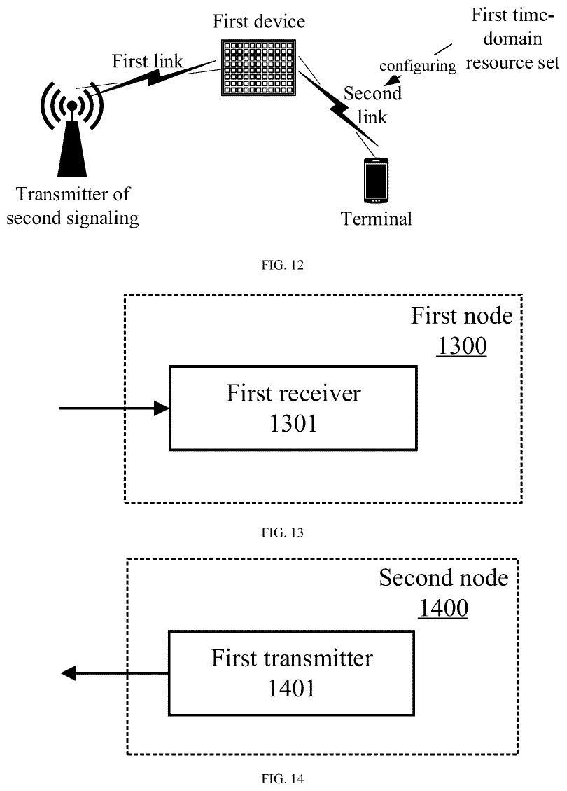

Embodiment 12 illustrates a schematic diagram of a first reference signal configured only for a second link according to one embodiment of the present application. In FIG. 12, a radio link between a transmitter of the second signaling and the first device is a first link, and a radio link between the first device and a terminal is a second link; the first time-domain resource set is only configured to a latter one of the first link and the second link.

In one embodiment, the meaning of the characteristic that “the first time-domain resource set is only configured to a latter one of the first link and the second link” comprises: the first time-domain resource set is configured to the second link.

In one embodiment, the meaning of the characteristic that “the first time-domain resource set is only configured to a latter one of the first link and the second link” comprises: the first time-domain resource set is not configured to the first link.

In one embodiment, the meaning of the characteristic that “the first time-domain resource set is only configured to a latter one of the first link and the second link” comprises: a radio signal on the second link is transmitted on the first time-domain resource set.

In one embodiment, the meaning of the characteristic that “the first time-domain resource set is only configured to a latter one of the first link and the second link” comprises: the first time-domain resource set is used to determine at least one of time-domain resources occupied by a radio signal on the second link, a number of time-domain resources occupied, a type of time-domain resources occupied, a time-domain position of a slot occupied, a position of a slot occupied in a cycle, a time-domain position of a multicarrier symbol occupied, a position of a multicarrier symbol occupied in a cycle, a position of a multicarrier symbol occupied in a slot, a time-domain position of a slot occupied by a multicarrier symbol occupied, and a position of a slot occupied by a multicarrier symbol occupied in a cycle.

### Embodiment 13

Embodiment 13 illustrates a structure block diagram of a processor in a first node according to one embodiment of the present application, as shown in FIG. 13. In FIG. 13, a processor 1300 in a first node comprises a first receiver 1301.

In embodiment 13, the first receiver 1301 receives a first signaling and a second signaling, the first signaling is used to configure a first RS resource, and a first radio resource depends on the second signal; the first receiver 1301 receives a first reference signal in the first RS resource;

In embodiment 13, the first RS resource is used for positioning, and whether a reception for the first reference signal is used for positioning depends on whether the first reference signal is associated with the first radio resource; a transmitter of the first signaling is different from a transmitter of the second signaling, and a transmitter of the second signaling is the same as a transmitter of the first reference signal.

In one embodiment, the first reference signal is associated with the first radio resource, and a reception for the first reference signal is used for positioning; or, the first reference signal is not associated with a first radio resource, and a reception for the first reference signal is not used for positioning.

In one embodiment, the first radio resource comprises a second reference signal, and the meaning of the phrase that the first reference signal is associated with the first radio resource comprises that the first reference signal and the second reference signal are spatially correlated.

In one embodiment, the first radio resource comprises a first time-domain resource set, and the meaning of the phrase that the first reference signal is associated with the first radio resource comprises that the first time-domain resource set comprises time-domain resources occupied by the first reference signal.

In one embodiment, the first radio resource is configured to a first device, the first node is a terminal, the first device is a device other than a terminal, and the first device is used to reflect a radio signal transmitted by a transmitter of the second signaling.

In one embodiment, a radio link between a transmitter of the second signaling and the first device is a first link, and a radio link between the first device and a terminal is a second link; the second reference signal is only configured to a latter one of the first link and the second link.

In one embodiment, a radio link between a transmitter of the second signaling and the first device is a first link, and a radio link between the first device and a terminal is a second link; the first time-domain resource set is only configured to a latter one of the first link and the second link.

### Embodiment 14

Embodiment 14 illustrates a structure block diagram of a processor in a second node according to one embodiment of the present application, as shown in FIG. 14. In FIG. 14, a processor 1400 of a second node comprises a first transmitter 1401.

In embodiment 14, the first transmitter 1401 transmits a second signaling, and a first radio resource depends on the second signaling; the first transmitter 1401 transmits a first reference signal in the first RS resource;

In embodiment 14, a first signaling is used to configure the first RS resource, the first RS resource is used for positioning, and whether a reception for the first reference signal is used for positioning depends on whether the first reference signal is associated with the first radio resource; a transmitter of the first signaling is different from the second node.

In one embodiment, the first reference signal is associated with the first radio resource, and a reception for the first reference signal is used for positioning; or, the first reference signal is not associated with a first radio resource, and a reception for the first reference signal is not used for positioning.

In one embodiment, the first radio resource comprises a second reference signal, and the meaning of the phrase that the first reference signal is associated with the first radio resource comprises that the first reference signal and the second reference signal are spatially correlated.

In one embodiment, the first radio resource comprises a first time-domain resource set, and the meaning of the phrase that the first reference signal is associated with the first radio resource comprises that the first time-domain resource set comprises time-domain resources occupied by the first reference signal.

In one embodiment, the first radio resource is configured to a first device, the first node is a terminal, the first device is a device other than a terminal, and the first device is used to reflect a radio signal transmitted by a transmitter of the second signaling.

In one embodiment, a radio link between a transmitter of the second signaling and the first device is a first link, and a radio link between the first device and a terminal is a second link; the second reference signal is only configured to a latter one of the first link and the second link.

In one embodiment, a radio link between a transmitter of the second signaling and the first device is a first link, and a radio link between the first device and a terminal is a second link; the first time-domain resource set is only configured to a latter one of the first link and the second link.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, vehicles, cars, RSUs, wireless sensors, network cards, Internet of Things (IoT) terminals, RFID (Radio Frequency Identification) terminals, NB-IoT (Narrow Band Internet of Things) terminals, Machine Type Communication (MTC) terminals, enhanced MTC (eMTC) terminals, data card, network cards, vehicle-mounted communication equipment, low-cost mobile phones, low-cost tablets and other wireless communication devices. The base station or system equipment in the present application includes but is not limited to macro cellular base stations, micro cellular base stations, small cellular base stations, home base stations, relay base stations, eNB (evolved Node B), gNB, TRP, GNSS (Global Navigation Satellite System), relay satellites, satellite base stations, airborne base stations, Road Side Units (RSUs), drones, testing equipment like transceiving device simulating partial functions of base station or signaling tester.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling and a second signaling, the first signaling being used to configure a first RS resource, a first radio resource depending on the second signal; receiving a first reference signal in the first RS resource;
wherein the first RS resource is used for positioning, and whether a reception for the first reference signal is used for positioning depends on whether the first reference signal is associated with the first radio resource; a transmitter of the first signaling is different from a transmitter of the second signaling, and a transmitter of the second signaling is the same as a transmitter of the first reference signal.

2. The first node according to claim 1, wherein the first reference signal is associated with the first radio resource, and a reception for the first reference signal is used for positioning; or, the first reference signal is not associated with a first radio resource, and a reception for the first reference signal is not used for positioning.

3. The first node according to claim 1, wherein the first radio resource comprises a second reference signal, and the meaning of the phrase that the first reference signal is associated with the first radio resource comprises that the first reference signal and the second reference signal are spatially correlated.

4. The first node according to claim 1, wherein the first radio resource comprises a first time-domain resource set, and the meaning of the phrase that the first reference signal is associated with the first radio resource comprises that the first time-domain resource set comprises time-domain resources occupied by the first reference signal.

5. The first node according to claim 1, wherein the first radio resource is configured to a first device, the first node is a terminal, the first device is a device other than a terminal, and the first device is used to reflect a radio signal transmitted by a transmitter of the second signaling.

6. The first node according to claim 5, wherein a radio link between a transmitter of the second signaling and the first device is a first link, and a radio link between the first device and a terminal is a second link; the second reference signal is only configured to a latter one of the first link and the second link.

7. The first node according to claim 5, wherein a radio link between a transmitter of the second signaling and the first device is a first link, and a radio link between the first device and a terminal is a second link; the first time-domain resource set is only configured to a latter one of the first link and the second link.

8. The first node according to claim 1, wherein the first signaling belongs to LPP messages.

9. The first node according to claim 1, wherein the first RS resource comprises one or multiple PRS resources.

10. The first node according to claim 1, wherein the meaning of the first radio resource depending on the second signaling comprises at least one of the following:
the second signaling indicates time-domain resources occupied by the first radio resource;
the second signaling indicates frequency-domain resources occupied by the first radio resource;
the second signaling indicates spatial-domain resources occupied by the first radio resource;
the second signaling indicates a QCL relation corresponding to the first radio resource;
the second signaling indicates reference signal resources spatially related to the first radio resource.

11. The first node according to claim 5, wherein the first device comprises a Reconfigurable Intelligent Surface (RIS).

12. The first node according to claim 6, wherein the first link is a control link, and the first link is for an RIS.

13. The first node according to claim 6, wherein the second link is a link between an RIS and a terminal.

14. A second node for wireless communications, comprising:
a first transmitter, transmitting a second signaling, a first radio resource depending on the second signaling; transmitting a first reference signal in a first RS resource;
wherein a first signaling is used to configure the first Reference Signal (RS) resource, the first RS resource is used for positioning, and whether a reception for the first reference signal is used for positioning depends on whether the first reference signal is associated with the first radio resource; a transmitter of the first signaling is different from the second node.

15. The second node according to claim 14, wherein the first reference signal is associated with the first radio resource, and a reception for the first reference signal is used for positioning; or, the first reference signal is not associated with a first radio resource, and a reception for the first reference signal is not used for positioning.

16. The second node according to claim 14, wherein the first radio resource comprises a second reference signal, and the meaning of the phrase that the first reference signal is associated with the first radio resource comprises that the first reference signal and the second reference signal are spatially correlated.

17. The second node according to claim 14, wherein the first radio resource comprises a first time-domain resource set, and the meaning of the phrase that the first reference signal is associated with the first radio resource comprises that the first time-domain resource set comprises time-domain resources occupied by the first reference signal.

18. The second node according to claim 14, wherein the first radio resource is configured to a first device, the first device is a device other than a terminal, and the first device is used to reflect a radio signal transmitted from the second node.

19. The second node according to claim 18, wherein a radio link between the second node and the first device is a first link, and a radio link between the first device and a terminal is a second link; the second reference signal is only configured to a latter one of the first link and the second link.

20. A method in a first node for wireless communications, comprising:
receiving a first signaling and a second signaling, the first signaling being used to configure a first RS resource, a first radio resource depending on the second signal; and
receiving a first reference signal in the first RS resource;
wherein the first RS resource is used for positioning, and whether a reception for the first reference signal is used for positioning depends on whether the first reference signal is associated with the first radio resource; a transmitter of the first signaling is different from a transmitter of the second signaling, and a transmitter of the second signaling is the same as a transmitter of the first reference signal.
